(19) United States
(12) Patent Application Publication
(10) Pub. No.: US 2009/0004557 A1
(43) Pub. Date: Jan. 1, 2009

(54) Protecting a functional component and a protected functional component

(75) Inventors: Harri Aukusti Lasarov, Espoo (FI); Sari Helena Tasa, Espoo (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/823,199

(22) Filed: Jun. 26, 2007

(51) Int. Cl. H01M 6/00; B05D 1/36; B32B 7/00

(52) U.S. Cl. 429/122; 427/402; 428/98

(57) ABSTRACT

An apparatus including a functional component; a first thermoset plastic layer overlying the functional component; and a second thermoset plastic layer, different to the first thermoset plastic layer, overlying the first thermoset plastic layer. A method including pre-protecting a functional component by: forming a first thermoset plastic layer over the functional component; and then forming a second thermoset plastic layer over the first thermoset plastic layer; and using the pre-protected component in an injection molding process.

### FIELD OF THE INVENTION

Embodiments of the present invention relate to protecting a functional component and a protected functional component. In particular, they relate to protecting functional components from physical damage.

### BACKGROUND TO THE INVENTION

It may in some circumstances be desirable to protect functional components such as batteries, displays, hard disk drives which are not necessarily damaged and can be relatively easily damaged.

For example, it may be desirable to protect the functional component against damage from physical impacts.

For example, it may be desirable to protect the functional component against damage during a manufacturing process used to integrate the functional component into a device.

### BRIEF DESCRIPTION OF VARIOUS EMBODIMENTS OF THE INVENTION

According to various embodiments of the invention there is provided an apparatus comprising: a functional component; a first thermoset plastic layer overlying the functional component; and a second thermoset plastic layer, different to the first thermoset plastic layer, overlying the first thermoset plastic layer.

The apparatus may be a finished product or an intermediate product that is further processed to create a finished product. The further processing may or may not include injection molding of thermoplastic.

According to various embodiments of the invention there is provided a method comprising: pre-protecting a functional component by: forming a first thermoset plastic layer over the functional component; and then forming a second thermoset plastic layer over the first thermoset plastic layer; and using the pre-protected component in an injection molding process.

The use of two different thermoset plastic layers enables the (internal) interface to the functional component and the (‘external’) interface of the apparatus to be independently controlled. The internal interface is provided by the first thermoset plastic layer whereas the ‘external’ interface is provided by the second thermoset plastic layer.

The internal interface may be configured, by selecting an appropriate first thermoset plastic, to provide particular physical characteristics that are beneficial in a material that is in contact with the functional component. Examples of such characteristics may include its ability to absorb energy from impacts, its ability to deform and/or its thermal properties such as thermal conductivity and/or specific heat capacity.

The ‘external’ interface may be configured, by selecting an appropriate second thermoset plastic, to provide particular physical characteristics that are beneficial in a material that forms an exterior or intermediate layer of a (finished product) apparatus. For example, if the second thermoset plastic layer forms the exterior of the apparatus as a finished product then it may be durable and hard wearing. For example, if the second thermoset plastic layer forms an intermediate layer which is overlain with a thermoplastic layer then the second thermoset plastic layer may be capable of withstanding the high pressures and thermal shock associated with the injection molding of thermoplastics. The second thermoset plastic layer may be more rigid, for example, than the first thermoset plastic layer.

### BRIEF DESCRIPTION OF THE DRAWINGS

For a better understanding of various embodiments of the present invention reference will now be made by way of example only to the accompanying drawings in which:

FIG. 1A schematically illustrates a functional component;

FIG. 1B schematically illustrates a first thermoset plastic layer overlying the functional component;

FIG. 1C schematically illustrates a second thermoset plastic layer overlying the first thermoset plastic layer and the functional component;

FIG. 2A schematically illustrates an injection molding process;

FIG. 2B schematically illustrates a product of the injection molding process.

### DETAILED DESCRIPTION OF VARIOUS EMBODIMENTS OF THE INVENTION

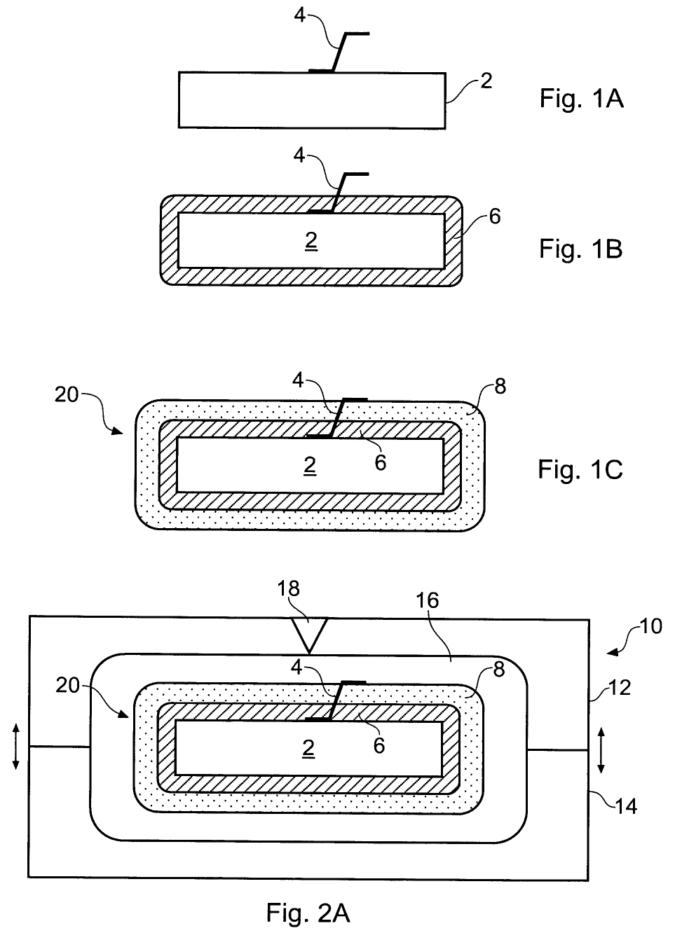

FIG. 1A schematically illustrates a functional component 2. The functional component is typically an electrical or electronic component that uses an electrical contact or contacts 4 to perform the component's function. A non-exhaustive list of suitable functional components may include a battery, a hard disk drive, a display.

A first thermoset plastic layer 6 is formed over the functional component 2 as illustrated schematically in FIG. 1B.

The first thermoset plastic layer 6 may encapsulate the functional component 2. Encapsulation may protect the functional component from water and/or dust ingress. Encapsulate in this context would mean that if the functional component were an N-sided rhomboid, the first thermoset plastic layer 6 would overlie each of the N-sides, however there may be absences of the first thermoplastic layer 6 at specific locations where such absences are required to enable the component 2 to perform its function. For example, the contact 4 may not be wholly covered by the first thermoset plastic layer 6. As another example, a screen of a display may not be overlaid unless the first thermoset plastic layer 6 is transparent.

The first thermoset plastic used for layer 6 may be a one component system or a two component system. The bases available for a thermoset plastic include urethane; epoxy and silicone base or combinations of these. In a one component system the thermoset plastic layer is cured in-situ using for example heat or UV-light. In a two component system the thermoset plastic layer is cured in-situ using a catalyst.

The properties of the first thermoset plastic layer 6 may be controlled by controlling which additives or/and fillers and how much are added to the thermoset plastic. The properties that can be controlled include the elasticity/rigidity and the thermal conductance. Filler materials include: quartz powder, zeolith, chalk, dolomite, aluminium hydroxide, glass- or metal fibres. Additives include: air release additives, wetting and dispersing agents, accelerators, release agents, anti-settling agents, surface additives, diluents, plasticisers, flame retardants, reaction delayers, flowing agents, thixotrope additives, light stabilizer, pigments etc. The following three general classes of fillers can be used to increase the thermal conductivity of thermoset plastic: carbon fillers e.g. carbon fibres and carbon powder; metallic fillers e.g. copper powder, steel, aluminium powder and aluminium flake; ceramic fillers e.g. boron nitride, aluminium nitride and aluminium oxide. With for example 2-component polyurethane material elasticity can be varied also by changing the ratio between polyol(s) and isocyanate components and also by changing both polyol(s) and isocyanate types.

As an example, the first thermoset plastic layer 6 may be formed from silicone thermoset have an elasticity of the order Shore A10 to A90. Such elasticity, results in the first thermoset plastic layer 6 acting as an effective absorber of physical impacts. The elasticity of the first thermoset plastic layer 6 may also allow it to deform/compress to accommodate size changes of the functional component 2 when it is in use. An example of a functional component 2 that changes size during use is a battery.

As another example, the first thermoset plastic layer 6 may be formed from polyurethane thermoset doped with ceramic filler to have a thermal conductivity of the order 0.1 to 100 W/mK. Such thermal conductivity enables the first thermoset plastic layer 6 to act as a heat sink when the functional component is in use. A natural high specific heat capacity of the first thermoset plastic layer absorbs large amounts of energy when required and slowly releases that energy thereby protecting the functional component from extremes of heat e.g. in injection molding process or cold.

A second thermoset plastic layer 8 is formed over the first thermoset plastic layer 6 as schematically illustrated in FIG. 1C. The second thermoset plastic layer has different properties than the first thermoset plastic layer 6. The different properties may include strength, stiffness, thermal conductivity etc

The resultant apparatus 20 comprises: a functional component 2; a first thermoset plastic layer 6 overlying the functional component 2; and a second thermoset plastic layer 8, different to the first thermoset plastic layer 6, overlying the first thermoset plastic layer 6.

The second thermoset plastic layer 8 may be a molded layer that forms an exterior portion of a housing for the functional component 2. The housing may also be a part of the housing of another apparatus such as a hand-portable electronic device which uses the functional component 2.

The second thermoset plastic layer 8 may encapsulate the first thermoset plastic layer 6 and the functional component 2. Encapsulation may protect the functional component from water and/or dust ingress. Encapsulate in this context would mean that if the functional component were an N-sided rhomboid, the second thermoset plastic layer 8 would overlie each of the N-sides, however there may be absences of the second thermoplastic layer 8 at specific locations where such absences are required to enable the component 2 to perform its function. For example, the contact 4 may not be wholly covered by the second thermoset plastic layer 8. As another example, a screen of a display may not be overlaid unless the second thermoset plastic layer 8 is transparent.

The second thermoset plastic used for layer 8 may be a one component system or a two component system. The bases available for a thermoset plastic include urethane; epoxy and silicone base. In a one component system the thermoset plastic layer is cured in-situ using for example heat or UV-light. In a two component system the thermoset plastic layer is cured in-situ using a catalyst.

The properties of the second thermoset plastic layer 8 may be controlled by controlling which additives or/and fillers and how much are added to the thermoset plastic. The properties that can be controlled include the elasticity/rigidity and the thermal conductance. Filler materials can include: quartz powder, zeolith, chalk, dolomite, aluminium hydroxide, glass- or metal fibres. Additives can include: air release additives, wetting and dispersing agents, accelerators, release agents, anti-settling agents, surface additives, diluents, plasticisers, flame retardants, reaction delayers, flowing agents, thixotrope additives, light stabilizer, pigments etc. The following three general classes of fillers can be used to increase the thermal conductivity of thermoset plastic: carbon fillers e.g. carbon fibres and carbon powder; metallic fillers e.g. copper powder, steel, aluminium powder and aluminium flake; ceramic fillers e.g. boron nitride, aluminium nitride and aluminium oxide. With for example 2-component polyurethane material elasticity can be varied also by changing the ratio between polyol(s) and isocyanate components and also by changing both polyol(s) and isocyanate types.

As an example, the second thermoset plastic layer 8 may be formed from polyurethane having a hardness of the order Shore A50 to Shore D90. The second thermoset plastic layer 8 is stiffer than the first thermoset plastic layer 6. The second thermoset plastic layer 8 acting as an effective shield against high pressures and sharp physical impacts whereas the first thermoset plastic layer may buffer the functional component 2 against physical impacts.

As another example, the second thermoset plastic layer 8 may be formed from epoxy doped with ceramic filler to have a thermal conductivity of the order 0.1-100 W/mK.

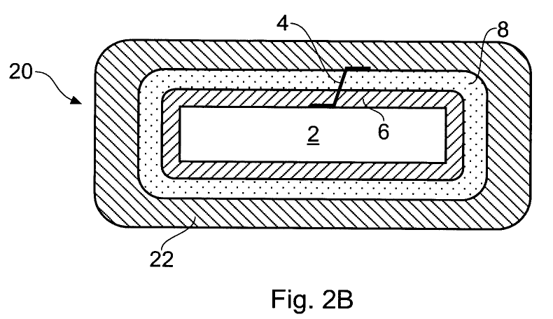

A thermoplastic layer 22 may be formed over the second thermoset plastic layer 8 as schematically illustrated in FIGS. 2A and 2B.

FIG. 2A schematically illustrates an injection molding process. A mold void 16 is formed by a first mold casing 12 and a second mold casing 14 in this example. The mold casings 12, 14 may be moved apart so that they can receive the apparatus 20 resulting from forming the second thermoset plastic layer 8. They are then moved together to define the void 16 surrounding the apparatus 20. Thermoplastic 22 is injected via one or more inlets 18. The thermoplastic is injected at high pressure (e.g. 10-300 Mpa) and at high temperature (150-400° C.). The thermoplastic fills the void 16. The first and second casings 12, 14 are then moved apart to release the apparatus 20 now encapsulated in thermoplastic 22 as illustrated in FIG. 2B.

The mold void 16 may be shaped such that the thermoplastic layer 22 forms an exterior portion of a housing for the functional component 2. The housing may also be a part of the housing of another apparatus such as a hand-portable electronic device which uses the functional component 2.

The functional component 2 may a component that could be damaged by the thermal shock and pressures associated with the injection molding process, particularly if exposed directly to the thermoplastic 22. The stiff second thermoset layer 8 shields the functional component 2 from the high pressures associated with injection molding. The second thermoset layer 8 does not bend or deform significantly under such pressures and the high pressure is not transferred to the functional component 2. The second thermoset layer 8 also protects the functional component 2 from thermal shock.

The functional component 2 has, in effect, been pre-protected before the injection molding process 10 is carried out. The pre-protection involves forming a first thermoset plastic layer 6 over the functional component 2, for example as illustrated in FIG. 1B; and then forming a second thermoset plastic layer 8 over the first thermoset plastic layer 6, for example as illustrated in FIG. 1C.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising
a functional component;
a first thermoset plastic layer overlying the functional component; and
a second thermoset plastic layer, different to the first thermoset plastic layer, overlying the first thermoset plastic layer.

2. An apparatus as claimed in claim 1, wherein the second thermoset plastic layer is harder than the first thermoset plastic layer.

3. An apparatus as claimed in claim 1, wherein the first thermoset plastic layer is more elastically deformable than the second thermoset plastic layer.

4. An apparatus as claimed in claim 1, wherein the first thermoset plastic layer has a higher thermal conductivity than the second thermoset plastic layer.

5. An apparatus as claimed in claim 1, wherein the first thermoset plastic layer is formed from polyurethane thermoset having an elasticity of the order Shore A10-Shore A90.

6. An apparatus as claimed in claim 1, wherein the second thermoset plastic layer is formed from epoxy thermoset to have a hardness of the order Shore A50-Shore D90.

7. An apparatus as claimed in claim 1, wherein the first thermoset plastic layer is formed from silicone doped with ceramic filler to have a thermal conductivity of the order 0.1-100 W/mK.

8. An apparatus as claimed in claim 1, wherein the second thermoset plastic layer is formed from polyurethane doped with ceramic filler to have a thermal conductivity of the order 0.1-100 W/mK

9. An apparatus as claimed in claim 1, wherein the second thermoset plastic layer is a molded layer forming an exterior portion of a housing for the functional component.

10. An apparatus as claimed in claim 1, further comprising a thermoplastic layer overlying the second thermoset plastic layer.

11. An apparatus as claimed in claim 1, wherein the thermoplastic layer is a molded layer forming an exterior portion of a housing for the functional component.

12. An apparatus as claimed in claim 1, wherein the thermoplastic layer encapsulates the second thermoset plastic layer.

13. An apparatus as claimed in claim 1, wherein the functional component is a sensitive component that would be damaged if exposed directly to a thermoplastic layer during an injection molding process.

14. An apparatus as claimed in claim 1, wherein the first thermoset plastic layer encapsulates the functional component.

15. An apparatus as claimed in claim 1, wherein the second thermoset plastic layer encapsulates the first thermoset plastic layer.

16. An apparatus as claimed in claim 1, wherein the functional component is a battery, wherein the first thermoset plastic layer has an elasticity such that when the battery expands in use, the first thermoset plastic layer compresses to accommodate the expansion.

17. An apparatus as claimed in claim 1, wherein the first thermoset plastic 6 and/or the second thermoset plastic 8 is an N-component system, where N is greater than or equal to 1, and wherein at least one of the N components is selected from the group comprising: a urethane base; an epoxy base and a silicone base

18. An apparatus as claimed in claim 1, wherein the functional component is an electrical or electronic component.

19. An apparatus as claimed in claim 1, wherein the functional component is selected from the group comprising: a battery, a hard disk drive, a display.

20. A method comprising:
pre-protecting a functional component by:
forming a first thermoset plastic layer over the functional component; and then
forming a second thermoset plastic layer over the first thermoset plastic layer; and
using the pre-protected component in an injection molding process.

21. A method as claimed in claim 20, wherein the second thermoset plastic layer operates as a heat and/or pressure shield during the injection molding process.

22. A method as claimed in claim 20, wherein the first thermoset plastic layer operates as a heat sink when the functional component is in use.

23. A method as claimed in claim 20, wherein the first thermoset plastic layer operates as an elastic buffer when the functional component is in use.
